(19) United States
(12) Patent Application Publication
(10) Pub. No.: US 2012/0091263 A1
(43) Pub. Date: Apr. 19, 2012

(54) Method of operating a solar aircraft

(75) Inventor: ROBERT PARKS, San Jose, CA (US)

(73) Assignee: AURORA FLIGHT SCIENCES CORPORATION, Manassas, VA (US)

(21) Appl. No.: 13/272,660

(22) Filed: Oct. 13, 2011

Related U.S. Application Data
(62) Division of application No. 12/211,027, filed on Sep. 15, 2008, now abandoned.
(60) Provisional application No. 60/972,720, filed on Sep. 14, 2007.

(51) Int. Cl. B64C 3/38

(52) U.S. Cl. 244/46

(57) ABSTRACT

A system and method for assembling and operating a solar powered aircraft, composed of one or more modular constituent wing panels. Each wing panel includes at least one hinge interface that is configured to rotationally interface with a complementary hinge interface on another wing panel. When a first and second wing panel are coupled together via the rotational interface, they can rotate with respect to each other within a predetermined angular range. The aircraft further comprises a control system that is configured to acquire aircraft operating information and atmospheric information and use the same alter the angle between the wing panels, even if there are multiple wing panels. One or more of the wing panels can include photovoltaic cells and/or solar thermal cells to convert solar radiation energy or solar heat energy into electricity, that can be used to power electric motors. Further, the control system is configured to alter an angle between a wing panel and the horizon, or the angle between wing panels, to maximize solar radiation energy and solar thermal energy collection. A tail assembly for the aircraft includes a rotational pivot that allows the flight control surfaces to rotate to different orientations to avoid or reduce flutter loads and to increase solar radiation energy and/or solar thermal energy collection from photovoltaic cells and/or solar thermal cells the can be located on the tail structure associated with the flight control surfaces.

### PRIORITY

This application is a divisional of U.S. patent application Ser. No. 12/211,027, filed Sep. 15, 2008, which claims the benefit of priority under 35 U.S.C. §119(e) from U.S. Provisional Application Ser. No. 60/972,720, entitled “NON-PLANAR ADAPTIVE WING SOLAR AIRCRAFT”, filed on Sep. 14, 2007, the entire contents of both incorporated herein by reference.

### BACKGROUND OF THE INVENTION

1. Field of the Invention

The invention relates to solar powered aircraft. More particularly, the invention relates to a system and method for altering a configuration of a solar-panel covered wing structure of a solar powered aircraft to increase collection of solar radiation during the day, while also minimizing power consumption at night.

2. Background Art

The concept of high-altitude, long-endurance solar powered aircraft has been demonstrated by a number of air vehicle research projects in the past. In 1974, AstroFlight built the first solar powered drone, Sunrise I. The promising results of the 32 foot span, Sunrise I, led to the Sunrise II, which with 4480 solar cells, was theoretically capable of attaining a service ceiling of 75,000 feet. Sunrise II flew successfully, but broke up in flight at 22,000 ft due to a suspected aeroelastic problem. The next advance in solar powered flight occurred in 1980 with AeroVironment's Gossamer Penguin, which performed the first human carrying solar flight, followed by the Solar Challenger, which reached an altitude of 12,000 feet on its flight across the English Channel. NASA's High Altitude Solar (HALSOL) project in 1995 saw the flight of the Pathfinder, which reached an altitude of 50,000 feet. This was followed by the Pathfinder-Plus which, with its new 19% efficient silicon solar cells, was able to reach 80,201 feet. The Pathfinder aircraft then led directly to the Centurion. The Centurion was aimed at creating an aircraft that would have a real world scientific application. The Centurion had a span of 206 feet with 62,120 bi-facial solar cells.

Under NASA's Environmental Research Aircraft and Sensor Technology Program, 1998-2003, the Centurion was modified to become Helios. The Helios prototype was designed as a proof of concept high-altitude unmanned aerial vehicle that could fly on long endurance environmental science or telecommunications relay missions lasting for weeks or months. Helios (shown in FIG. 1) made use of 19% efficient silicon based solar cells on the upper wing and lithium batteries. Helios had a constant 8 foot chord and was assembled in six 41-foot sections with under-wing pods at the juncture of each section. Helios reached an altitude-record setting 96,000 feet on solar power. Helios subsequently broke up in-flight in other testing. The in-flight break-up was caused when a gust-induced aeroelastic wing shape change led to a control system instability. The resulting pitch oscillation resulted in excessive speeds which caused failure of the wing covering. The wing spar actually withstood deflections 150% of the design configuration. In 2005, AC Propulsion developed the SoLong aircraft. With the energy storage advances made with Li-Ion batteries (220 Whr/kg), SoLong was able to stay airborne for two half nights, starting with a charged battery at midnight and flying to midnight the next day. This initial 24 hour flight was followed a few months later with a full 48 hour flight. In 2007, the English company Qinetiq flew the Zephyr 54 hours. This aircraft has taken advantage of both 25% efficient solar cells and 350 Whr/kg Lithium Sulfur batteries.

The best example of previously built and flown state of the art is the AeroVironment aircraft, culminating in the Helios. Much of this is described in U.S. Pat. No. 5,810,284, to Hibbs, et al. (hereinafter, the Hibbs patent). The Hibbs patent shows a very large wingspan aircraft, with the solar collection and other mass distributed along a very high aspect ratio wing. This allowed the use of a very light wing spar, and the simple, clean design consumed very low power during the night. As discussed in great detail below, night time power usage is especially critical, because the storage system is quite heavy, and there is a storage “round trip” efficiency. This means that a large amount of solar energy must be collected to provide even a small amount of power at night. In the example given in the Hibbs patent, 2.5 Watt hours of electrical power had to be collected during the day to provide 1 Watt hour at night.

However, a significant limitation of the airplane disclosed in the Hibbs patent is that it is poor at collecting energy during the winter time at high latitudes. For example, London, England is approximately 51.5 degrees latitude. At winter solstice, the peak elevation of the sun above the horizon is only 15 degrees, and the horizontal solar collector, as shown in the Hibbs patent, will collect at most 25% of the energy it would collect with the sun overhead. Another significant limitation is that at high latitudes, the aircraft must fly predominantly towards the west, so the sun, at peak elevations, will be predominantly off the left wingtip. Thus the normal flexing of the wing, such as shown in flight on Helios, aims much of the wing panels away from the sun, while also putting some of the remainder of the wing in the shadow of the left wing tip. Thus the net collection capability is likely only about 15% of what it could optimally collect with the sun overhead. The poor collection geometry of the airplane disclosed in the Hibbs patent (i.e., the horizontal solar panels), combined with short days and long nights makes it very difficult for the Hibbs' airplane to collect enough solar energy.

Nevertheless, improved collection geometry has been suggested in the prior art. An example is shown in U.S. Pat. No. 4,415,133, issued in 1983 to Phillips (hereinafter the Phillips patent). This configuration is also shown in NASA Technical Paper 1675, “Some Design Considerations for Solar-Powered Aircraft,” published in June, 1980, also by Phillips. The cruciform configuration shown is capable of flying in any desired roll attitude, and thus can have its solar array track the sun in elevation. While the cruciform configuration disclosed in the Phillips patent provides improved solar energy collection than the configuration shown in the Hibbs patent, it has twice as much wing area as is needed to produce lift, and thus incurs a significant penalty in drag and thus energy required to fly, especially during the night (when no solar radiation energy collection can occur).

Another NASA study published in 1983, Contractor Report CR-3699 by Hall, Dimiceli, Fortenbach and Parks, entitled “A Preliminary Study of Solar Powered Aircraft and Associated Power Trains” (hereinafter the 1983 NASA C. Report) looked at, among other things, a wide range of configurations that attempted to combine both low power consumption at night with good solar radiation energy collection geometry during the day. Some of these configurations are shown in FIGS. 46 and 47 of the report, on pages 120 and 121 respectively. Configurations 2 and 3 in FIG. 46 shows aircraft that have pointable collectors, but exhibit high drag both during days and nights. FIG. 4 shows an early attempt to combine improved solar energy collection with good night time power efficiency. As those of ordinary skill in the art can appreciate, however, only one of the elevated wing panels has good solar energy collection. For westward flight with the sun off the left wing-tip, the left wing has poor solar energy collection, as mentioned above, and can shadow the right wing.

Variable geometry designs are shown in FIG. 47 of the 1983 NASA C. Report, particularly in configurations 14, 17 and 18. All of these have a large wing span, and all of the wing provide lift for low night time energy consumption. Configurations 17 and 18 are symmetric in both day and night modes, but require solar cells on the bottom of one tip and on the top of the other. This is good for typical westerly winds, but for the occasional easterly winds, cells would be needed on both sides of both tips, which is both a mass and cost penalty. Configuration 14 of FIG. 47 provides solar cells on top of both tips, but is not symmetric, and it was believed that the control systems of the time would not be able to fly the airplane.

Furthermore, in configurations 14, 17 and 18, the wing-tips were only able to be oriented vertically or horizontally. Thus, while they were pretty good at solar radiation energy collection with the sun on the horizon or overhead, their solar radiation energy collection is significantly reduced when the sun is at 30° to 40° elevation angle with respect to the horizon.

A significant shortcoming of all three configurations shown in FIG. 47 of the 1983 NASA C. Report is that when the wing-tips are vertical, they cannot support their own weight. As a result, a large downwardly directed load is brought upon the tips of the center section. To enable the aircraft to support such large load factors, a large structural mass is designed into the aircraft. Because the tips cannot support their own weight, the fraction of the span that could be pivoted up is limited.

In U.S. Pat. No. 7,198,225, issued in 2007, to Lisoski and Kendall (hereinafter referred to as the Lisoski patent), which also relates to the Helios type aircraft, a variant of Helios is proposed with variable wing angles to improve solar radiation energy collection, as shown in FIGS. 6E and 6F. However, as those of ordinary skill in the art can appreciate, the configurations shown in FIGS. 6E and 6F of the Lisoski patent are essentially the same concept shown in FIG. 46 of the 1983 NASA C. Report, configuration 4.

All of the above concepts have some problems with either solar collection at low sun elevation angles, sun collection at medium sun elevation angles, night time energy requirements or excessive structural mass. Thus, there is a need for a solar aircraft configuration that can effectively adapt to a wide range of sun angles, does not carry collectors that are not useful at some sun angles, has very low drag for low night time energy requirements, and also does not require excessive structural mass, and thus can allocate a large mass to the energy storage system.

While the historical solar powered aircraft have increased flight duration and altitude over time, none have exhibited the ability to fly at high latitudes, nor have any shown greater duration than perhaps a day or two. Thus, historical solar powered aircraft all have limitations due to poor high latitude solar collection efficiency due to the horizontal nature of their arrays and insufficient energy storage to fly through a long winter night.

Thus, a need exists for a solar powered aircraft that can overcomes the deficiencies of the prior art, by operating at high latitudes and during long periods of darkness.

### SUMMARY OF THE INVENTION

It is therefore a general aspect of the invention to provide a solar powered aircraft that will obviate or minimize problems of the type previously described.

According to a first aspect of the present invention, an aircraft is provided, comprising: at least a first wing panel, wherein the first wing panel includes at least one hinge interface, wherein each of the at least one hinge interfaces are configured to rotationally interface with a complementary hinge interface on at least a second wing panel, such that the first wing panel can rotate with respect to the second wing panel within a predetermined angular range; and a control system, wherein the control system is configured to acquire aircraft information and atmospheric information, and further wherein the control system is configured to use the acquired aircraft information and acquired atmospheric information to alter the angle between the first wing panel and the second wing panel.

According to the first aspect, the wing panel comprises: an upper and lower surface, wherein one or both of the upper and lower surfaces includes one or more photovoltaic cells, wherein each of the one or more photovoltaic cells is configured to convert solar radiation energy into electricity. Still further according to the first aspect, the control system is further configured to alter the angle between the first and second wing panels to substantially maximize collection of solar radiation energy.

According to the first aspect, the aircraft further comprises at least one battery or other energy storage device configured to store electrical energy generated by the photovoltaic cells, and still further comprises at least one electrically driven motor. Further still, the aircraft is a solar powered aircraft.

According to the first aspect, the aircraft information is selected from the group consisting of, velocity information of the aircraft, altitude information of the aircraft, attitude information of the aircraft, acceleration information of the aircraft, position information of the aircraft with respect to the earth, and position information of the aircraft with respect to the sun.

According to the first aspect, the atmospheric information is selected from the group consisting of wind speed and direction information, temperature, atmospheric pressure, and relative humidity.

According to the first aspect, the wing panel of the aircraft further comprises: an upper and lower surface, wherein one or both of the upper and lower surfaces includes at least one solar thermal collection cell, wherein each of the at least one solar thermal collection cell is configured to convert solar thermal energy into electricity.

According to the first aspect, the control system is further configured to alter the angle between the first and second wing panels to substantially maximize collection of solar radiation energy.

According to the first aspect, the aircraft further comprises at least one battery or other energy storage device, configured to store electrical energy generated by the photovoltaic cells, and still further comprises at least one electrically driven motor.

According to the first aspect, the aircraft further comprises any number of additional wing panels, wherein each of the any number of additional wing panels includes at least one hinge interface, wherein each of the at least one hinge interfaces are configured to rotationally interface with a complementary hinge interface on an adjacent wing panel, such that each of the adjacent wing panels can rotate with respect to any of the wing panels including the adjacent wing panels within a predetermined angular range; and wherein the control system is further configured to alter the angle between any pair of adjacent wing panels coupled together by the at least one hinge interface.

According to the first aspect, the control system is further configured to alter an angle between at least one of the wing panels and the horizon, and the control system is further configured to alter the angle between at least one of the wing panels and the horizon in order to substantially maximize collection of solar energy.

According to the first aspect, the one or more of the wing panels comprises control surfaces configured to alter or maintain flight characteristics of the aircraft, and wherein the control system is further configured to unlock at least one of the hinge interfaces and use control surface deflections and a turn rate of the aircraft to reposition the wing panels coupled together.

According to the first aspect, the aircraft further comprises a tail boom; and a tail structure, and wherein the tail structure includes a plurality of control surfaces configured to alter or maintain flight characteristics of the aircraft, at least one or more photovoltaic cells, and a rotational pivot configured to rotationally attach the tail structure to the tail boom, and further wherein the control system is configured to manipulate the plurality of control surfaces to rotate the tail structure about a central axis of the tail boom via the rotational pivot.

According to the first aspect, the control system is further configured to rotate the tail structure to collect solar radiation energy via the photovoltaic cells, and the control system is further configured to rotate the tail structure to maximize collection of solar radiation energy via the photovoltaic cells. Still further according to the first aspect, the control system is further configured to rotate the tail structure to substantially decrease flutter loads on the tail structure.

According to the first aspect, the aircraft further comprises a tail boom; and a tail structure, and wherein the tail structure includes a plurality of control surfaces configured to alter or maintain flight characteristics of the aircraft, at least one or more solar thermal collection cells, and a rotational pivot configured to rotationally attach the tail structure to the tail boom, and further wherein the control system is configured to manipulate the plurality of control surfaces to rotate the tail structure about a central axis of the tail boom via the rotational pivot.

According to the first aspect, the control system is further configured to rotate the tail structure to collect solar thermal energy via the at least one or more solar thermal collection cells, and the control system is further configured to rotate the tail structure to maximize collection of solar thermal energy via the at least one or more solar thermal collection cells.

According to the first aspect, the aircraft further comprises a tail boom; a motor; and a tail structure, and wherein the tail structure includes a plurality of control surfaces configured to alter or maintain flight characteristics of the aircraft, at least one or more photovoltaic cells, and a rotational pivot configured to rotationally attach the tail structure to the tail boom, and further wherein the control system is configured to operate the motor to rotate the tail structure about a central axis of the tail boom via the rotational pivot.

According to the first aspect, the control system is further configured to rotate the tail structure to collect solar radiation energy via the photovoltaic cells, and the control system is further configured to rotate the tail structure to maximize collection of solar radiation energy via the photovoltaic cells.

According to the first aspect, the aircraft further comprises a tail boom; a motor; and a tail structure, and wherein the tail structure includes a plurality of control surfaces configured to alter or maintain flight characteristics of the aircraft, at least one or more solar thermal collection cells, and a rotational pivot configured to rotationally attach the tail structure to the tail boom, and further wherein the control system is configured to operate the motor to rotate the tail structure about a central axis of the tail boom via the rotational pivot.

According to the first aspect, the control system is further configured to rotate the tail structure to collect solar thermal energy via the at least one or more solar thermal collection cells, and the control system is further configured to rotate the tail structure to maximize collection of solar thermal energy via the at least one or more solar thermal collection cells.

According to the first aspect, the wing panel of the aircraft comprises an upper and lower surface, wherein one or both of the upper and lower surfaces includes one or more dipole antenna elements, wherein each of the one or more dipole antenna elements is configured to transmit and receive electromagnetic energy.

According to the first aspect, the control system is further configured to alter the angle between the first and second wing panels to substantially maximize transmission gain and reception gain of each of the one or more dipole antenna elements with respect to a remote transceiver, and wherein the control system is further configured to transmit electromagnetic energy to, and receive electromagnetic energy from, a transceiver located at an altitude higher than the aircraft, and wherein the control system is further configured to transmit electromagnetic energy to, and receive electromagnetic energy from, a transceiver located at an altitude lower than the aircraft.

According to the first aspect, the first wing panel includes a first dipole antenna element; and the second wing panel includes a second dipole antenna element, and the control system is further configured to alter the angle between the first and second wing panels, such that the transmission and reception gain of the first dipole antenna element is substantially maximized with respect to a first transceiver at a first location, and the transmission and reception gain of the second dipole antenna element is substantially maximized with respect to a second transceiver at a second location, such that communications can occur between the first and second transceivers through the first and second dipole antenna elements.

According to a second aspect of the present invention, a tail assembly for use on an aircraft is provided comprising: a tail boom; and a tail structure, wherein the tail structure includes a plurality of control surfaces configured to alter or maintain flight characteristics of the aircraft, at least one or more photovoltaic cells, or at least one or more solar thermal collection cells, or both photovoltaic cells and solar thermal collection cells, and a rotational pivot configured to rotationally attach the tail structure to the tail boom, and further wherein the control system is configured to manipulate the plurality of control surfaces to rotate the tail structure about a central axis of the tail boom via the rotational pivot.

According to the second aspect, the control system is further configured to rotate the tail structure to collect solar radiation energy via the photovoltaic cells, or the at least one or more solar thermal collection cells, or both the photovoltaic cells and the solar thermal collection cells, and the control system is further configured to rotate the tail structure to substantially maximize collection of solar radiation energy via the photovoltaic cells or the at least one or more solar thermal collection cells, or both the photovoltaic cells and the solar thermal collection cells. Further still, the control system is further configured to rotate the tail structure to substantially decrease flutter loads on the tail structure.

According to a third aspect of the present invention, a tail assembly for use on an aircraft is provided comprising: a tail boom; a motor; and a tail structure, wherein the tail structure includes a plurality of control surfaces configured to alter or maintain flight characteristics of the aircraft, at least one or more photovoltaic cells, or at least one or more solar thermal collection cells, or both photovoltaic cells and solar thermal collection cells, and a rotational pivot configured to rotationally attach the tail structure to the tail boom, and further wherein the control system is configured to operate the motor to rotate the tail structure about a central axis of the tail boom via the rotational pivot.

According to the third aspect, the control system is further configured to rotate the tail structure to collect solar radiation energy via the photovoltaic cells, or the at least one or more solar thermal collection cells, or both the photovoltaic cells and the solar thermal collection cells, and the control system is further configured to rotate the tail structure to substantially maximize collection of solar radiation energy via the photovoltaic cells or the at least one or more solar thermal collection cells, or both the photovoltaic cells and the solar thermal collection cells. Furthermore, according to the third aspect, the control system is further configured to rotate the tail structure to substantially decrease flutter loads on the tail structure.

According to a fourth aspect of the present invention, an aircraft is provided, comprising: a wing panel, wherein the wing panel includes an upper and lower surface, and wherein one or both of the upper and lower surfaces includes one or more photovoltaic cells, wherein each of the one or more photovoltaic cells is configured to convert solar radiation energy into electricity; and a control system, wherein the control system is configured to acquire aircraft information and atmospheric information, and further wherein the control system is configured to use the acquired aircraft information and atmospheric information to alter the angle between the wing panel and a horizon, to substantially maximize collection of solar radiation energy.

According to the fourth aspect, the aircraft further comprises at least one battery or other energy storage device configured to store electrical energy generated by the photovoltaic cells, and the aircraft further comprises at least one electrically driven motor.

According to the fourth aspect, the aircraft information is selected from the group consisting of velocity information of the aircraft, altitude information of the aircraft, attitude information of the aircraft, acceleration information of the aircraft, position information of the aircraft with respect to the earth, and position information of the aircraft with respect to the sun.

According to the fourth aspect, the atmospheric information is selected from the group consisting of wind speed and direction information, temperature, atmospheric pressure, and relative humidity.

According to a fifth aspect of the present invention, a method of operating an aircraft is provided, comprising the steps of: rotating a first wing panel with respect to a second wing panel, wherein the first and second wing panels are rotational coupled; collecting solar radiation energy by photovoltaic cells located on one or both of an upper and lower surface of each of the first and second wing panels; and energizing an electrical motor.

According to the fifth aspect, the step of rotating the wing panel comprises: optimizing collection of solar radiation energy by the photovoltaic cells by rotating each of the first and second wing panels such that each is at an optimal angle with respect to the sun.

According to the fifth aspect, the method further comprises rotating any number of wing panels, wherein each wing panel is rotationally coupled to at most two adjacent wing panels and at least one adjacent wing panel, such that each of the any number of wing panels can be rotated within a predetermined angular range with respect to each adjacent wing panel; and optimizing collection of solar radiation energy by the photovoltaic cells on each wing panel by rotating each of the any number of wing panels such that each is at an optimal angle with respect to the sun.

### BRIEF DESCRIPTION OF THE DRAWINGS

The novel features and advantages of the present invention will best be understood by reference to the detailed description of the preferred embodiments that follows, when read in conjunction with the accompanying drawings, in which:

FIG. 1 illustrates a known solar cell powered aircraft.

FIG. 2 illustrates a day time and night configuration of a solar powered aircraft implementing the non-planar adaptive wing structure with three wing panels according to an embodiment of the present invention.

FIG. 3 illustrates a front perspective view of a solar powered aircraft implementing a non-planar adaptive wing structure with five wing panels according to an embodiment of the present invention.

FIG. 4 is a block diagram illustrating a comparison of solar collection area and solar cell efficiency between a known wing structure configuration versus a non-planar adaptive wing structure according to an exemplary embodiment of the present invention.

FIG. 5 is a graph illustrating a comparison of operating latitude versus time of year between conventional wing structures and the non-planar adaptive wing structure according to an embodiment of the present invention.

FIG. 6 is a graph illustrating lift and drag affects of varying wing geometries using a non-planar adaptive wing structure according to an embodiment of the present invention.

FIG. 7 is a graph illustrating wing panel lift generation for a particular configuration of a non-planar adaptive wing structure according to an embodiment of the present invention.

FIG. 8 is a graph illustrating optimal wing panel elevation (in degrees from horizontal) for a non-planar adaptive wing structure according to an embodiment of the present invention.

FIG. 9 is a graph illustrating wing panel angles versus time of day for a particular flight path using a non-planar adaptive wing structure according to an embodiment of the present invention.

FIG. 10 is a graph illustrating net power collection for a particular configuration of a non-planar adaptive wing structure versus net power collection for a flat wing structure according to an embodiment of the present invention.

FIG. 11 is a graph illustrating net power collection and net power usage for an aircraft with the non-planar adaptive wing structure according to an embodiment of the present invention.

FIG. 12 illustrates a right side view of a tail assembly for use with a solar powered aircraft and non-planar adaptive wing structure according to an embodiment of the present invention.

FIG. 13 illustrates a front perspective view of a tail structure for use with a solar powered aircraft and non-planar adaptive wing structure according to an embodiment of the present invention.

FIG. 14. illustrates a front perspective view of a solar powered aircraft implementing the non-planar adaptive wing structure and a dipole antenna embedded onto the wing structure according to an embodiment of the present invention.

FIG. 15 illustrates the solar powered aircraft as shown in FIG. 14 used as a communication transceiver according to an embodiment of the present invention.

FIG. 16 illustrates a block diagram of an engine housing for use in the solar powered aircraft shown in FIGS. 1-15 according to an embodiment of the present invention.

FIGS. 17A-17C illustrate several combinations of wing panel dihedral angles and wing panel elevation angles of the solar powered aircraft shown in FIGS. 1-15 according to an embodiment of the present invention.

### DETAILED DESCRIPTION OF THE PREFERRED EMBODIMENTS

The various features of the preferred embodiments will now be described with reference to the drawing figures, in which like parts are identified with the same reference characters. The following description of the presently contemplated best mode of practicing the invention is not to be taken in a limiting sense, but is provided merely for the purpose of describing the general principles of the invention.

According to exemplary embodiments, the system and method for a non-planar adaptive wing structure can work on several different types of aircraft. According to a preferred embodiment, the system and method for a non-planar adaptive wing structure can work on a solar powered aircraft. Thus, the discussion below should not be construed to be limited to any one particular type of aircraft. By way of example only, and according to a preferred embodiment, discussion is made of light, unmanned aerial vehicles. More particularly, and according to a preferred embodiment, the discussion below refers to solar powered modular constituent unmanned aerial vehicles (MC UAVs). The UAVs are referred to as “modular constituent” because they are designed to be fit together, and are generally and substantially identical. As those of ordinary skill in the present art can appreciate, however, even though each UAV can comprise the appropriate hardware and controller components to allow non-planar adaptive wing structure, the UAV's themselves can be of different shapes, sizes, and with different payloads and capabilities, yet still can accomplish non-planar adaptive wing structure according to exemplary embodiments.

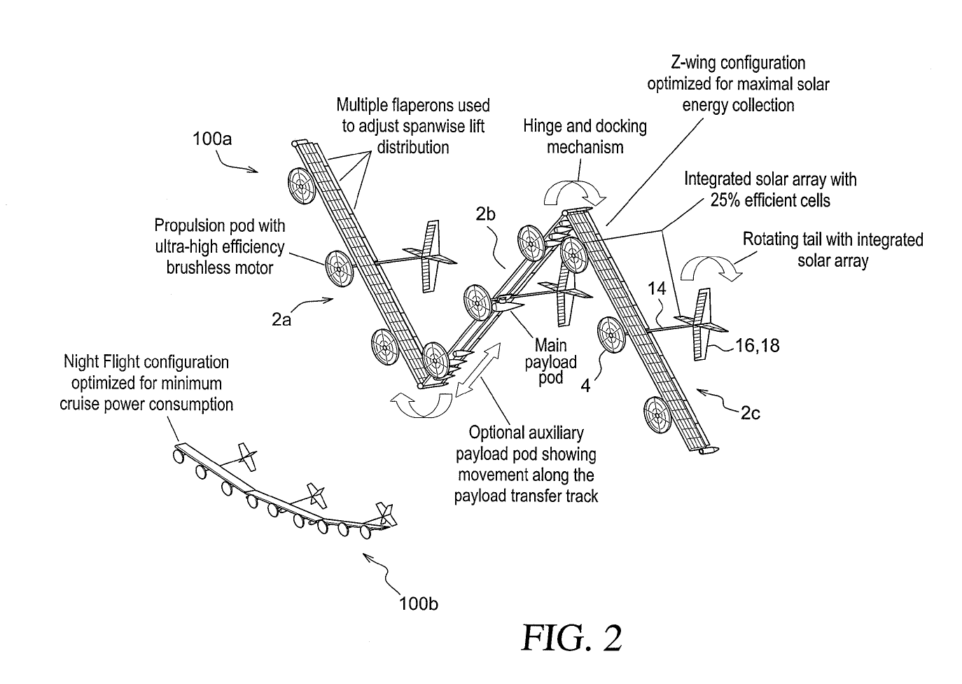

FIG. 2 illustrates a day time and night time configuration of the solar powered aircraft (aircraft) 100 implementing the non-planar adaptive wing structure according to an exemplary embodiment. According to a preferred embodiment, the design of aircraft 100 was developed based on a careful analysis of the driving requirements: the system should provide significant utility; the system must provide several years of uninterrupted operation; the system should carry and operate a significant payload while consuming a reasonable amount of power; the system must provide station-keeping with a substantial probability of being on-station; and the system must provide a high probability of mission success.

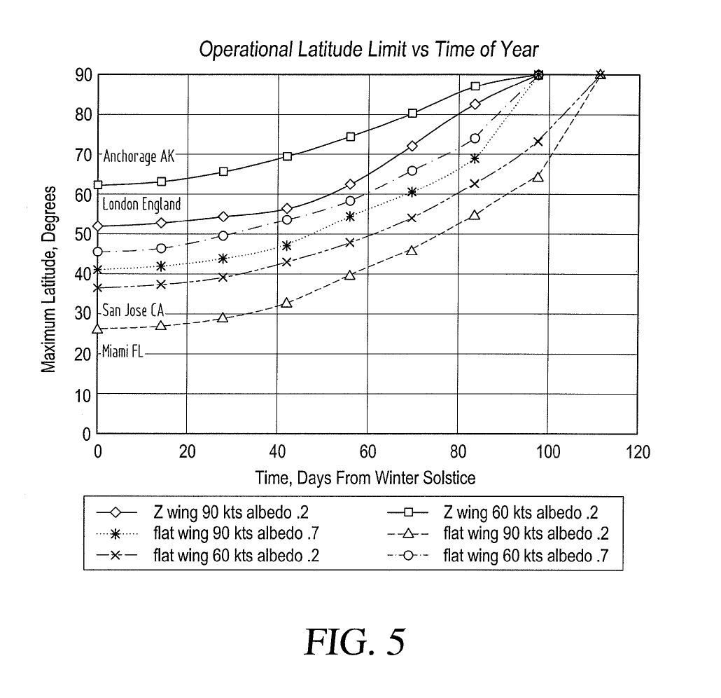

According to an exemplary embodiment, aircraft 100 is composed of multiple substantially identical solar regenerative fuel cell electric propulsion modular constituent UAV's (MC UAVs 2). As discussed above, MC UAV's 2 are connected together; this enables aircraft 100 to incorporate a non-planar adaptive wing structure according to an exemplary embodiment. An alternate embodiment would have a single aircraft with multiple wing panels permanently attached with hinges that allow the non-planar adaptive wing structure. The non-planar adaptive wing structure allows ultra-efficient flight during the night (as shown in FIG. 5), while positioning wing panels 8 and tail structure 16 mounted solar arrays 24 in an optimal orientation with respect to the sun to substantially maximize solar collection efficiency during the day (see FIG. 2). MC UAV's 2a can be connected wing tip-to-wing tip using rotational hinge interfaces (hinge interface) 12. Although not visible in FIG. 2, a first hinge interface 12 at a first end of MC UAV 2 will complement a second hinge interface 12 located at a second end of MC UAV 2. Thus, two, three, or four or more MC UAVs 2 can be coupled together; each of the MC UAVs 2 will face the same direction during docking and following, during flight of aircraft 100.

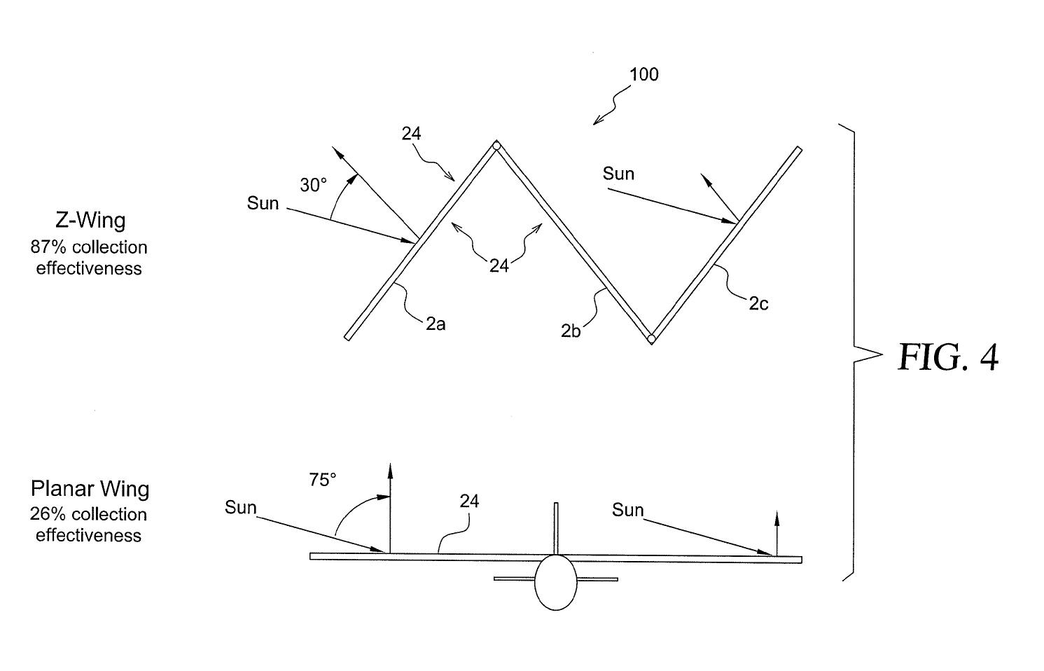

Hinge interface 12 allow aircraft 100 to adapt a ‘Z-wing’ geometry according to an exemplary embodiment for efficient solar energy collection at high latitudes, as shown FIG. 4. FIG. 5 illustrates the potential payoff in operating latitude (the nonplanar adaptive wing structure air vehicle is referred to as “Z wing” in these and several other accompanying figures). FIG. 5 illustrates the differences between a conventional flat wing and aircraft 100, both with advanced technology energy systems. To generate the data in FIG. 5, calculations are performed and data is derived when both the conventional vehicle (flat wing) and aircraft 100 according to an exemplary embodiment are configured to be flying a constant day-time heading of 270°, with nighttime flight speeds of 60 and 90 knots. Aircraft 100 allows coverage to northern latitudes of up to 60° at winter solstice. The 60° northern latitude line traverses north of all of the United Kingdom, through Oslo, Norway, St. Petersburg, Russia, through the northern part of the Sea of Okhotsk, Russia, across the Bering Sea to the southern part of Alaska, and through the northern part of Canada. In contrast, Miami, Fla. is just above the 25° northern latitude line, and is approximately parallel with the Sahara, Saudi-Arabia, northern India, Taipei, Taiwan, and Culiacan, Mexico.

According to exemplary embodiments, aircraft 100 comprises a wing length of between about 100 meters and about 200 meters. According to a preferred embodiment, the wing length of aircraft 100 is about 150 meters. According to exemplary embodiments, aircraft 100 comprises a wing chord of between about 2.5 meters and about 7.5 meters. According to a preferred embodiment, the wing chord of aircraft 100 is about 5 meters. According to exemplary embodiments, aircraft 100 comprises a tail size that is between about 15% and about 25% of the total wing area. According to a preferred embodiment, the tail size of aircraft 100 is about 20% of the total wing area. According to exemplary embodiments, aircraft 100 can maintain a constant indicated air speed of between about 53 meters-per-second (m/s) and about 73 m/s. According to a preferred embodiment, aircraft 100 can maintain an indicated air speed of about 63 m/s. According to exemplary embodiments, aircraft 100 can operate at an altitude of about 22.5 kilometers. According to a preferred embodiment, aircraft 100 can operate at an altitude of about 21.5 kilometers. According to exemplary embodiments, aircraft 100 operates at a wing loading of between about 35 pascals and about 45 pascals. According to a preferred embodiment, aircraft 100 operates at a wing loading of about 40 pascals. According to exemplary embodiments, aircraft 100 comprises a coefficient of wing lift C_{L} of between about 0.53 and about 0.59. According to a preferred embodiment, aircraft 100 comprises a coefficient of wing lift C_{L} of about 0.56. According to exemplary embodiments, aircraft 100 comprises double-sided energy storage cells with an efficiency of between about 30% and about 50%, while allowing for between about 15% and about 25% loss due to shadowing on the wings' lower surface(s). According to a preferred embodiment, aircraft 100 comprises double-sided energy storage cells with an efficiency of about 40%, while allowing for about 20% loss due to shadowing on the wings' lower surface(s). According to exemplary embodiments, aircraft 100 comprises an energy storage between about 700 Whr/kg and about 900 Whr/kg. According to a preferred embodiment, aircraft 100 comprises an energy storage of about 800 Whr/kg. As those of ordinary skill in the art can appreciate, the above-described quantities for various aircraft specifications, including wing span, energy storage, energy consumption, and several other specifications and quantities, have been provided solely for purposes of illustration, and not limitation in any manner whatsoever.

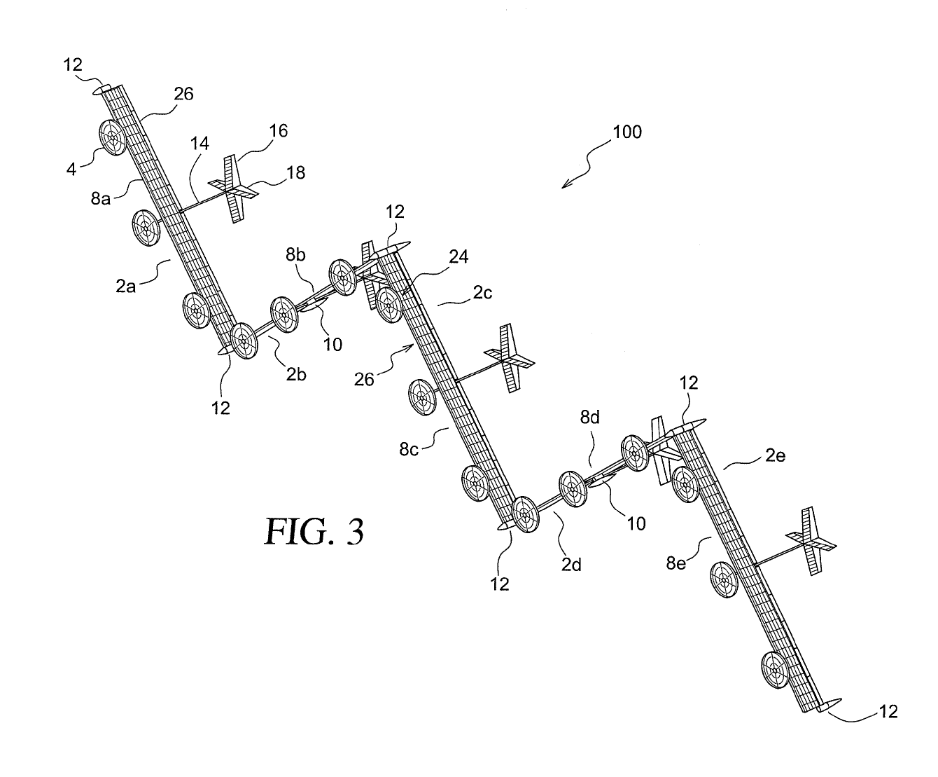

FIGS. 2 and 3 illustrates a front perspective view of a solar powered aircraft (aircraft 100) implementing a non-planar adaptive wing structure according to an exemplary embodiment. According to an exemplary embodiment, aircraft 100 comprises either three or five MC UAVs 2a-e, and as shown in FIG. 3, each MC UAV 2 includes at least one propulsion unit 4, wing panel 8, hinge interfaces 12, MC UAV control surfaces 26, solar radiation panels 24 (on either or both an upper and lower wing panel surface), energy storage system 6 (not shown), tail boom 14 (with rotational pivot 20), tail structure 16 (each with tail structure control surfaces 18), and payload 10. As those of ordinary skill in the art can appreciate, not every MC UAV 2 necessarily must include payload 10; however, the remaining structures are required to take off, fly and assemble the individual MC UAVs 2 at or near the operating altitude. As shown in FIG. 2, payloads 10 can be stored on a payload transfer track to move them along wing panel 8. According to an exemplary embodiment, hinge interfaces 12 can rotate through an angular range of about 100°. According to a preferred embodiment hinge interfaces can rotate through and angular range of about 90°.

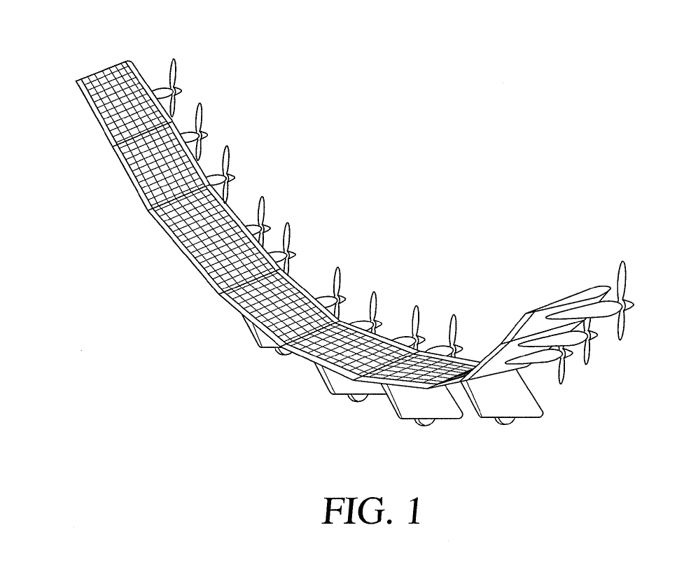

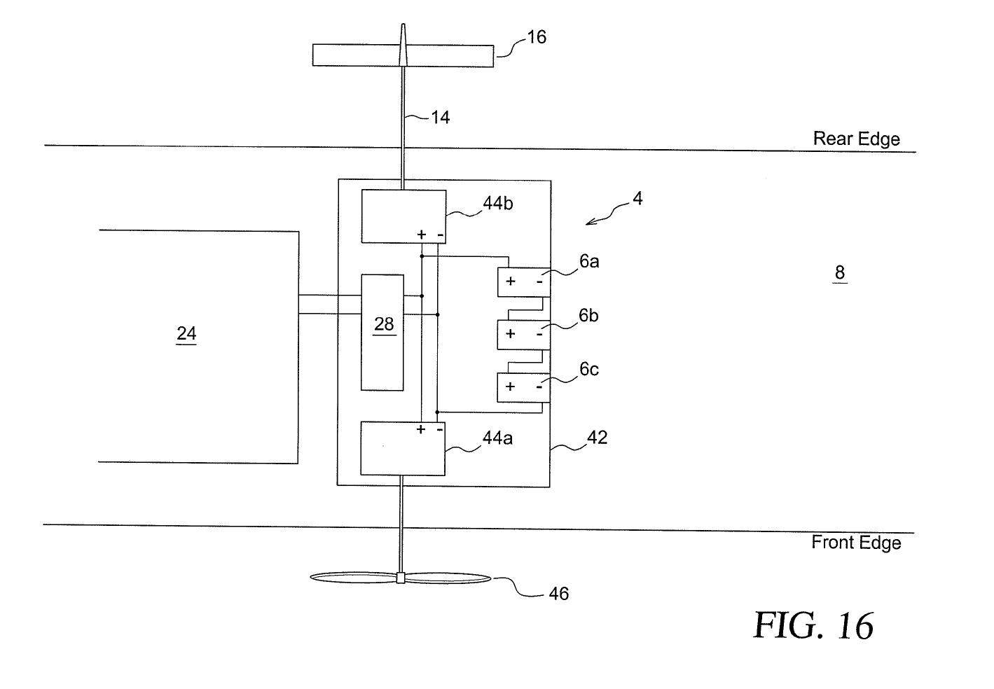

FIG. 16 illustrates a block diagram of an engine housing for use in the solar powered aircraft shown in FIGS. 1-15 according to an exemplary embodiment. Referring to FIG. 16, propulsion system 4 is shown to include engines 44a, b, energy storage systems 6 (according to an exemplary embodiment, these are batteries, and according to a preferred embodiment, energy storage system 6 is a lithium-ion (Li-ion) type battery, and flight control system (controller) 28. All of these components are housed within engine compartment housing (housing) 42. According to an exemplary embodiment, locating batteries 6a-c together in housing 42, near engines 44a, b, and controller 28 utilizes waste heat generated by engine 44 and controller 28 to keep batteries 6 warm. Batteries 6 and other energy storage systems 6 operate better when warm as those of ordinary skill in the art can appreciate. Furthermore, by co-locating batteries 6 with engine 44, and controller 28, an advantage in mass balancing occurs, where the mass of any tail booms and tail surfaces is offset by the mass of the forward located batteries. In addition, keeping the mass forward on a flexible wing will reduce the chances of torsion to flapping mode interaction which can result in wing flutter.

As discussed below, in regard to tail boom 14, tail structure 16 and rotational pivot 20, cruciform tails with solar radiation panels 24 that are flown to track the sun elevation provide significant benefits in solar energy collection. According to an exemplary embodiment, tail structure 16 can also provide improved control over the aeroelastic modes, both in damping and in control power. As those of ordinary skill in the art can appreciate, many different types of materials can be used in constructing various components of MC UAV 2. For example, according to exemplary embodiments, wrapped carbon fiber and/or wrapped carbon epoxy, carbon fiber, kevlar cable, aluminum extrusions, molded carbon fiber laminates and carbon fiber foam sandwich structures can be used for many different component structures of MC UAV 2. Still further, molded carbon fiber laminates and machined aluminum, and machined titanium with bonded karon bearing surfaces can be used for other structures. Kapton or Tedar film, kevlar skinned foam, and carbon skinned balsa can be used for still other components structures of MC UAV 2 according to exemplary embodiments. According to a preferred embodiment, the main structure of MC UAV 2 can be fabricated from carbon, with a conductor embedded therein. A main structure fabricated in this manner means that the main structure can act as a power bus for different electrical components. Structural aluminum could be used, but the resistance is generally about two times that of pure aluminum (which cannot be used because it is too soft). In a structure that is designed for stiffness, the soft aluminum could still give an advantage. If carbon is used to manufacture the main structure of MC UAV 2, then aluminum is preferably not used as a conductor because of the well known effects of galvanic corrosion. Other metals that can be used with carbon include copper, or aluminum that is electrically isolated from the carbon by a layer of fiberglass.

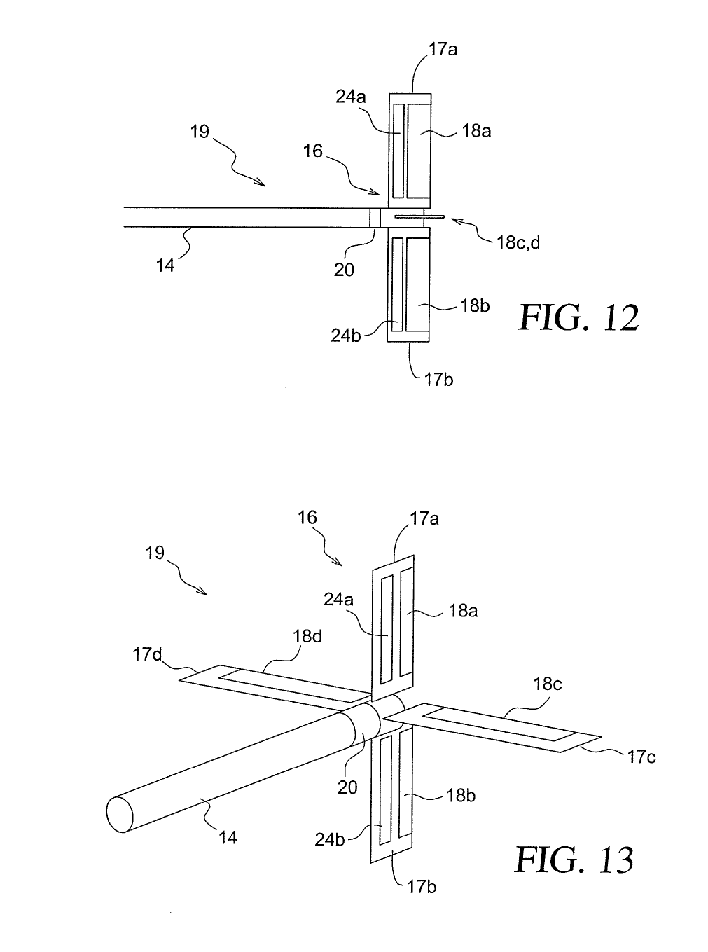

Rotation of hinge interfaces 12 is controlled by a control system 22, discussed in greater detail below. Rotation of aircraft 100 as shown in FIG. 2 includes rotation of MC UAV 2a with respect to MC UAV 2b (or visa-versa) and rotation of MC UAV 2b with respect to MC UAV 2c (or visa-versa). Furthermore, as shown in FIG. 2, aircraft 100a illustrates that tail structure 16 can rotate about tail boom 14 through use of rotational pivot 20 (shown in FIG. 13). According to a preferred embodiment, rotating tail structure 16 with solar radiation panels 24 about tail boom 14 can substantially maximize collection of solar radiation by positioning tail structure 16 at the best angle with respect to the then current position of the sun. Rotation of tail structure 16 with respect to tail boom 14 and consequent operation of aircraft 100 will be discussed in greater detail below.

FIG. 4 is a block diagram illustrating a comparison of solar collection area and solar cell efficiency between a known wing structure configuration versus a non-planar adaptive wing structure according to an exemplary embodiment. Aircraft 100, which comprises at least one or more MC UAVs 2, can alter the angle between MC UAVs 2. As a result, solar radiation collection panels 24 that can occupy both upper and lower surfaces of wing panels 8 according to exemplary embodiments can improve solar radiation collection by as much as 400% with respect to a planar horizontal wing, as FIG. 4 illustrates.

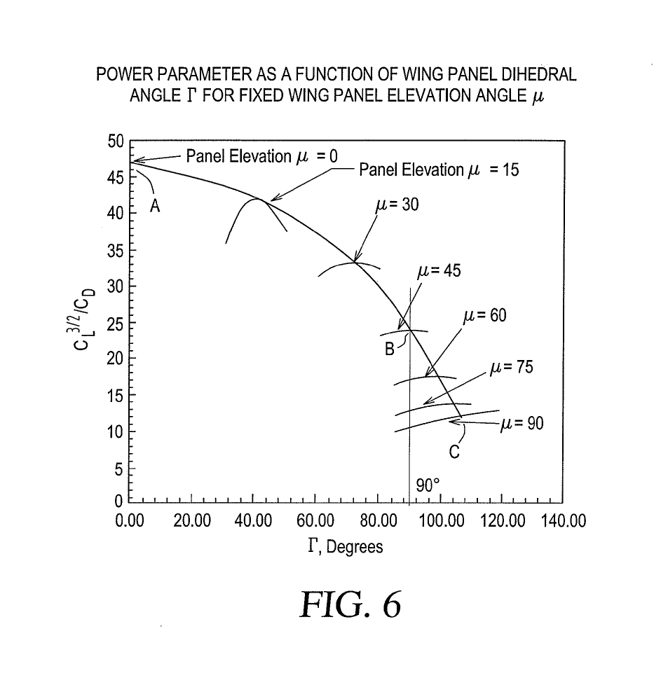

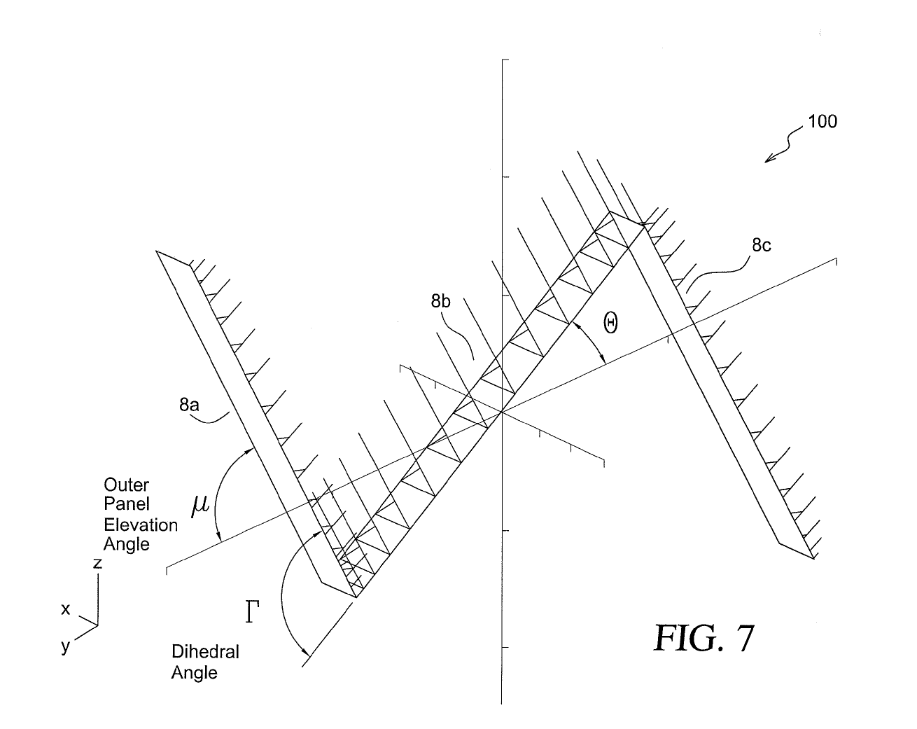

FIG. 6 is a graph illustrating lift and drag affects of varying wing geometries using a non-planar adaptive wing structure according to an exemplary embodiment. Despite its geometric complexity, the aerodynamics of aircraft 100 can be analyzed effectively by a combination of vortex-lattice and airfoil analysis methods. Aircraft 100 has the capability to position the outer wing panels 8a, c at a wide range of angles with respect to the horizon, called the panel elevation angle μ, to enhance the energy collection. Referring briefly to FIG. 7, Panel elevation angle θ is the angle that, in a three wing panel 8a-c MC UAV 2 configuration, center wing panel 8b forms (or flies at) with respect to the horizon. The dihedral angle Γ, is the angle that outer wing panels 8a, c forms with respect to the center wing panel 8b. According to an exemplary embodiment, MC UAV 2 can be formed from any number of wing panels 8. According to a preferred embodiment, however, MC UAV 2 is formed or created from three wings panels 8a-c.

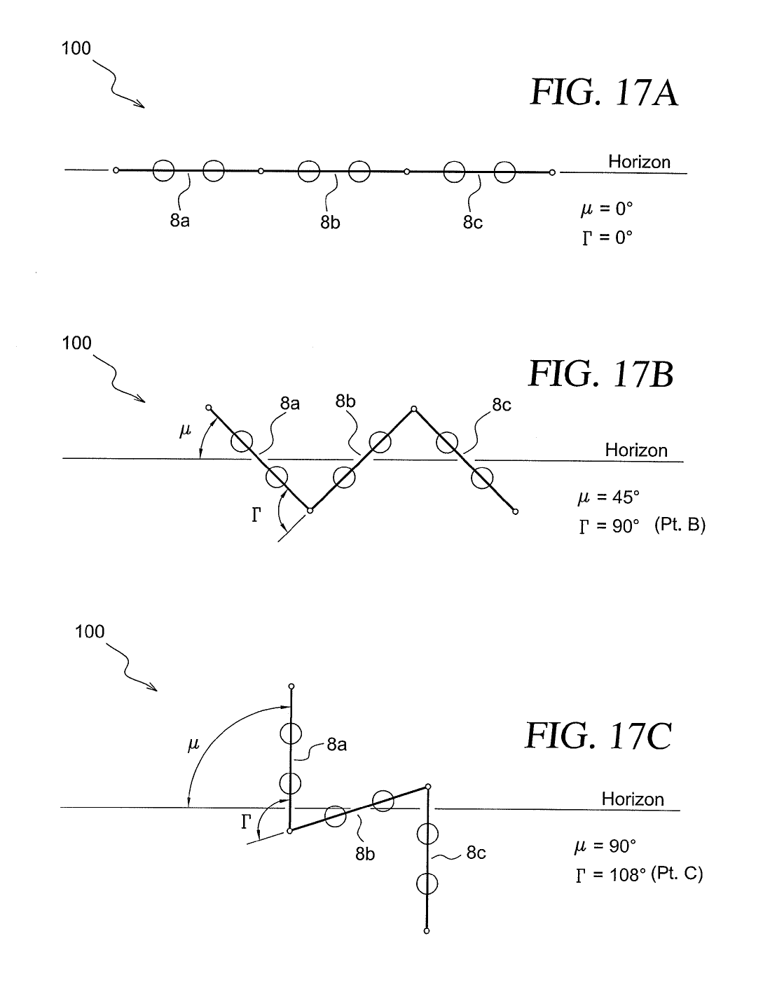

When wing panels 8 are not lifting substantially vertically (i.e., when the wing panels 8 are at an angle with respect to the horizon (see FIG. 7, for example), the lift vector can be resolved into horizontal and vertical components), there is a penalty in extra power required to fly aircraft 100. According to an exemplary embodiment, one combination of panel angles that balances the forces and allows straight and level flight requires wing panel 8b (the center section) to be inclined to the horizontal in the opposite direction to the inclination of the tip wing panels 8a, c. According to an exemplary embodiment, a first order Athena Vortex Lattice (AVL) software study (a method of analyzing aerial vehicles, providing aerodynamic analysis, trim calculations, dynamic stability analysis, among other features), was performed to determine the vertical lift production and drag of a series of configurations with outer wing panel 8 angle (otherwise known as the dihedral angle, or Γ), measured relative to the horizontal wing configuration. That is, the dihedral angle, or Γ, is the angle between adjacent wing panels 8. The results are shown in FIG. 6. In FIG. 6, “μ” represents the outer wing panel 8 elevation (or bank or roll) angle with respect to the horizon. For each configuration, the joint dihedral angle Γ was varied, resulting in a series of center wing panel 8 inclination angles θ. According to this exemplary embodiment, tip wing panel 8a and tip wing panel 8c formed a substantially identical angle Γ with respect to center wing panel 8b (as shown in FIG. 7). For each case, the analysis solved for the angle of attack to give a required vertical lift and the sideslip angle to produce zero side force. According to a preferred embodiment, less than 1° of aileron deflection was then needed to produce zero rolling moment, resulting in a fully trimmed flight condition. For any given panel inclination angle μ there is an optimal center section inclination angle θ that produces the minimum total power requirement. The power vs. dihedral angle curves are shown in FIG. 6, along with the curve of optimum dihedral to minimize power, for the range of outer panel inclination angles from 0 to 90°. The optimal case for the 90° panel inclination has the center section rolled over about 20° away from the sun, because the side force generated by the banked center section causes the vertical outer panels to produce an opposing side force. This produces an overall wing lift distribution similar to that on a winglet on a normal wing, with similar drag reduction advantages. FIGS. 17A-17C illustrate several combinations of wing panel dihedral angles and wing panel elevation angles of the solar powered aircraft shown in FIGS. 1-15 according to an exemplary embodiment. In FIG. 17A, outer panel elevation angle is 0° and panel dihedral angle is 0°. In FIG. 17B, outer panel elevation angle is 45° and panel dihedral angle is 90° (point B on the curve shown in FIG. 6). In FIG. 17C, outer panel elevation angle is 90° and panel dihedral angle is about 108° (point C on the curve shown in FIG. 6).

As discussed above, there are several methods for controlling aircraft 100. Control system 22 can operate in an autonomous mode, or can accept remote control signals from a remote operator. Such remote operators can transmit signals via line-of-sight transmissions, through satellite communication systems, or from the ground to another aircraft to aircraft 100, and through other methods. Furthermore, control system 22 can control the configuration of aircraft 100 in several ways. First, it can forward commands to a motor that is associated with each of several hinge interfaces 12 that can then cause a first wing panel 8a to rotate with respect to second wing panel 8b (and so on for other wing panels 8). Or, control system 22 can interpret commands given to it via a remote operator (or from itself when operating in the autonomous mode) to put aircraft 100 in a particular configuration (i.e., wing outer panel elevation angle μ, wing panel dihedral angle Γ), by rolling aircraft 100 through manipulation of its ailerons to create enough force to cause wing panels 8a-c to move with respect to one another if they are unrestricted at the appropriate moment. That is, control system 22 can cause the ailerons to roll aircraft 100; as aircraft 100 rolls, control system 22 “unlocks” one or more hinge interfaces at the appropriate moment such that the angular momentum created by the roll is sufficient to cause a first wing panel 8 to move in relationship to an adjacent wing panel 8. In this manner, battery power is conserved; the size of the batteries can be reduced, and the weight and space savings can be used for additional payload, or other items.

FIG. 7 is a graph illustrating wing panel 8 lift generation for a particular configuration of a non-planar adaptive wing structure according to an exemplary embodiment. FIG. 7 illustrates span-wise and chord-wise lift distribution for aircraft 100 with about 90° dihedral and about 60° outer panel elevation angle μ through use of an AVL computation. According to an exemplary embodiment, aircraft 100 is in a trimmed condition with about zero side force and about zero rolling moment.

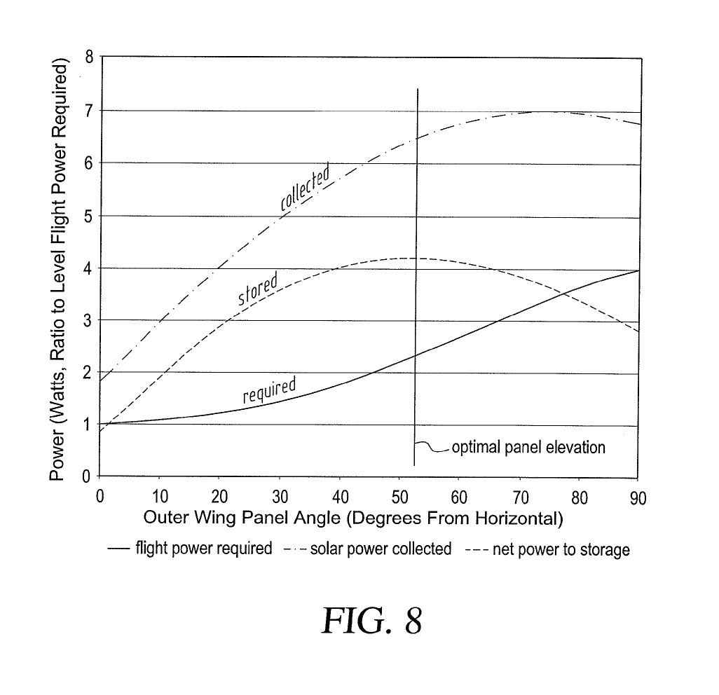

FIG. 8 is a graph illustrating optimal wing panel elevation angle μ (in degrees from horizontal) for a non-planar adaptive wing structure, i.e., aircraft 100, according to an exemplary embodiment. Once the power required vs. wing outer panel elevation angle μ is determined, it is possible to calculate both power required for flight vs. power collected. The amount of power required for flight versus that of solar power collected will vary with the elevation of the sun, and the aircraft characteristics, but a typical case according to an exemplary embodiment is shown in FIG. 8. In this case, the sun is directly off a first wing panel tip, with an elevation of about 15° above the horizon. For high latitudes, the long night and energy storage losses require that the power collected be several times the normal flight power. In this case, according to an exemplary embodiment, the factor is approximately 4:1. A wing outer panel elevation angle μ of about 0°, with no wing panel dihedral angle Γ (horizontal wing; see FIG. 17A) requires minimum flight power, but exhibits a low solar power collection efficiency of about 25%. As can be seen from FIG. 8, when wing panel elevation angle μ is about 0°, the power collected is not enough to charge batteries for a long night. If aircraft 100 flies solely on solar power, it will soon lose all of the energy stored in its batteries, because not enough power is going into the batteries to replace that which is consumed.

A wing panel elevation angle μ of about 75° gives 100% collection efficiency, but a large amount of that power is needed to fly aircraft 100. According to a preferred embodiment, a wing panel elevation angle μ of about 52° provides the highest net power (shown by the vertical line in FIG. 8), by combining moderate flight power while maintaining a collection efficiency of about 92%. At this point on the graph shown in FIG. 8, the amount of power being stored is at a maximum value. The stored power values are the difference between the power collected and the amount of power required to operate aircraft 100.

Based upon air vehicle's 100 configuration as determined in FIG. 8, its performance can be simulated by stepping through a typical day and recalculating the power required and the power collected. At each point, the sun angles relative to aircraft 100 are calculated, and the wing dihedral angle Γ, and wing outer panel elevation angle μ are iterated to find the angles that deliver the largest amount of power to the payload and energy storage system. Both the sun elevation and the azimuth angles are significant, as is the heading of aircraft 100. Because the worst case flight condition for a solar powered aircraft is overcoming extreme strong winds, and the available wind data indicates that strong winds at high latitudes in the winter are predominantly westerly, a constant daytime heading of about 270° was used for most of the trade studies. The other worst case scenario is with minimum sun and lowest sun elevation angles, which is the winter solstice, nominally December 23 in the Northern Hemisphere.

Aircraft 100 is capable of flying at northern (or southern) latitudes more efficiently than flat wing panel aircraft due to its ability to vary the wing panel elevation angle μ and wing panel dihedral angle Γ. At lower northern latitude, that is, as the latitude approaches the equator (from both sides), the overall advantage of aircraft 100 is still significant over flat panel aircraft, but does begin to decrease. In one significant manner, however, aircraft 100 maintains a clear advantage in that at sunrise and sunset aircraft 100 can sustain higher powered flight better than a flat wing panel aircraft due to its ability to gather more of the setting or just rising sun than a flat wing panel solar powered aircraft.

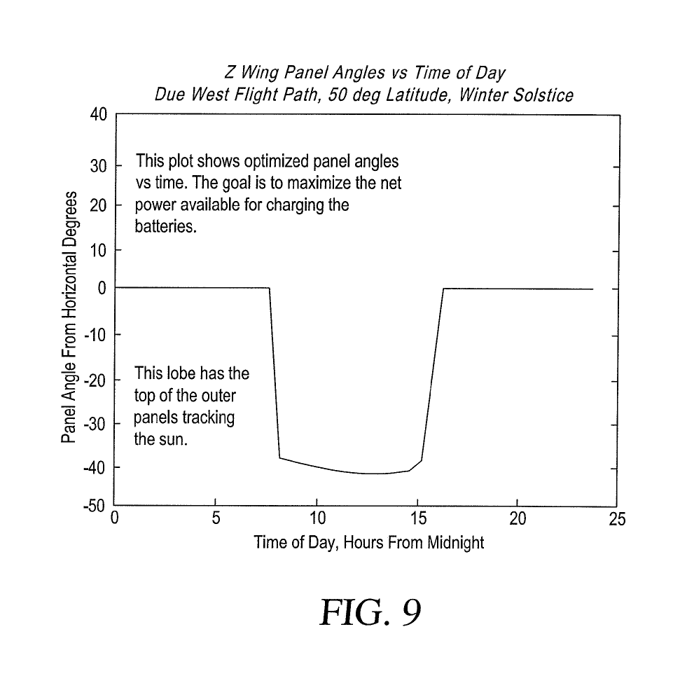

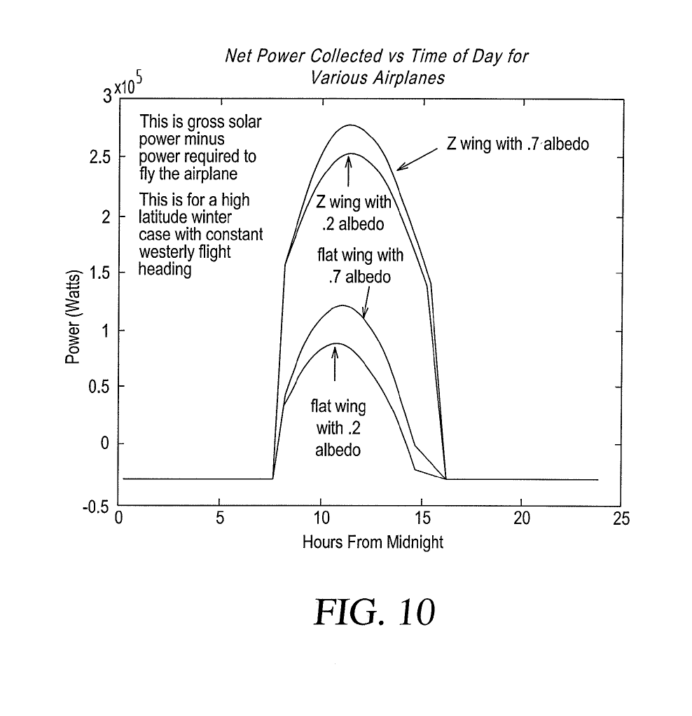

FIG. 9 is a graph illustrating wing panel elevation angle μ versus time of day for a particular flight path using a non-planar adaptive wing structure according to an exemplary embodiment; FIG. 10 is a graph illustrating new power collection for a particular configuration of a non-planar adaptive wing structure according to an exemplary embodiment; and FIG. 11 is a graph illustrating a net power collection and net power usage for an aircraft with the non-planar adaptive wing structure according to an exemplary embodiment. Output from a typical day is shown in FIGS. 9-11, wherein aircraft 100 is simulated to be operated at a latitude of about 50° north. The critical day has about 8 hours of daylight, about 16 hours of night, and the highest elevation of the sun above the horizon is approximately 16°.

FIG. 9 illustrates the optimal wing panel elevation angle μ for power collection. According to an exemplary embodiment, aircraft 100 that was used to generate the data shown in FIG. 9 has solar radiation panels 24 on an upper side of wing panels 8. As a result, the cells are angled aft about 15° due to the airfoil shape and the wing angle of attack. For most of the day, the outer wing panels 8 are aimed towards the sun with panel angles of about 50° from the horizontal. However, in the late afternoon the sun has moved to the southwest of aircraft 100, and the aft slope of wing panels 8 provides poor efficiency.

The power numbers for the day are plotted in FIG. 11, showing the flight power plus payload power, the total electrical power out of the solar radiation panels 24, and the net power going in or out of the energy storage system 6. As a comparison, FIG. 10 illustrates the net power for aircraft 100 with the non-planar adaptive wing structure in a “Z” configuration according to an exemplary embodiment versus the power for aircraft 100 with wing panels 8 locked in about a horizontal position. According to a preferred embodiment, there is about a 300% improvement in the net power collected.

FIG. 10 also shows the effect of albedo (the fraction of incident electromagnetic radiation reflected by a surface, especially of a celestial body, e.g., the earth), with two cases shown for each aircraft. An albedo of about 0.7 corresponds to an ‘undercast’ of clouds, providing high reflectance, while an albedo of about 0.2 is appropriate for bare ground in the early winter. The albedo makes a significant difference in the performance of the flat wing aircraft, but relatively little difference in aircraft 100 with the non-planar adaptive wing structure in a “Z” configuration. A fundamental problem with relying on albedo for high northern latitude performance (or low southern latitude performance) is that while much of the 40° to 60° north latitude band has cloud cover, there can be significant ‘holes’ at times. If a day with low albedo is near winter solstice and if it also corresponds with high winds, aircraft that depended on albedo would have very low energy and could be blown off station, or be unable to sustain flight.

FIG. 11 is a graph illustrating net power collection and net power usage for aircraft 100 implementing the non-planar adaptive wing structure according to an exemplary embodiment. FIG. 11 illustrates power collection, power storage, and power use for aircraft 100 implementing the non-planar adaptive wing structure according to an exemplary embodiment during the winter solstice and at about a 50° northern latitude. For any solar powered long duration aircraft, it is crucial to minimize night time energy usage, and to maximize day time energy production. Line A in FIG. 11 represents power used by the motors; Line B represents the gross power out of solar panels 24; and Line C represents net energy storage into (positive amount) or out of (negative amount) energy storage system (batteries) 6. Referring now to Line A, at night time, from about 0 to about 8 or so hours past midnight, the amount of energy used by the engines is substantially constant. The energy used is substantially constant because aircraft 100 flies with its wings flat and with maximum wing span, and is generally not tracking the sun. As a result, energy usage is minimized. From about 8 hours past midnight, to about 16 or so hours past midnight, the energy usage of the engines is substantially more, as Line A indicates; it shoots sharply upward, then flattens out for the entire day and drops off fairly sharply at the end of the flying day. During this day time period, aircraft 100 optimizes its tracks of the sun; It rotates its wing panels into the Z configuration this provides greater energy into the batteries 6, but also uses more than flying with the wing flat.

Line B represents the gross power out of solar panels 6. From about 0 hours past midnight to about 8 hours past midnight, there is no energy input. Then, at about 8 hours past midnight, the sun rises and the power out of solar panels 6 climbs dramatically, especially because aircraft 100 is now tracking the sun. At about 16 hours or so past midnight, till about 8 hours or so past midnight, the power output from solar panels 6 drops off equally dramatically, and falls to zero as the sky becomes dark.

Line C represents the net energy flow into batteries 6. During the dark hours, from about 8 hours before midnight to about 8 hours after midnight, there is a net energy loss with respect to batteries 6. During the daylight hours, from about 8 hours past midnight to about 16 hours past midnight, there is a net energy flow into batteries 6. Of course, without a make-up in energy from solar cells 6, aircraft 100 would eventually fail to have enough battery power and would drop out of the sky. As those of ordinary skill in the art can appreciate, FIG. 11 represents the worst case scenario, during the winter solstice, when the daylight hours are at their shortest in the northern hemisphere.

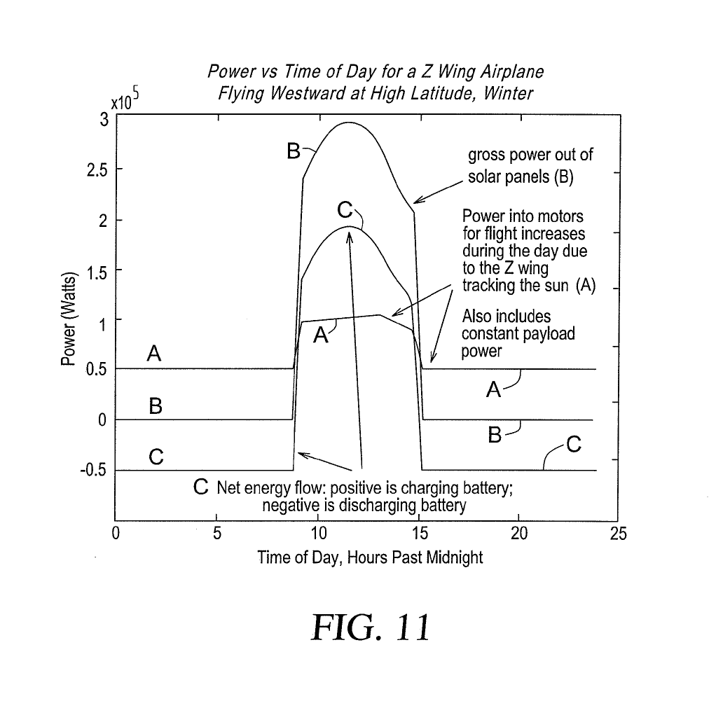

FIG. 12 illustrates a right side view of tail assembly 19 for use with aircraft 100 and the non-planar adaptive wing structure according to an exemplary embodiment, and FIG. 13 illustrates a front perspective view of tail assembly 19 for use with aircraft 100 and the non-planar adaptive wing structure according to an exemplary embodiment. As shown in FIGS. 12 and 13, tail assembly 19 comprises tail boom 14, rotational pivot 20, and tail structure 16. Tail structure 16, according to an exemplary embodiment, includes one or more stabilizers 17, and according to a preferred embodiment, includes four tail stabilizers 17a-d. According to an exemplary embodiment, each tail stabilizer 17 includes flight control surface 18. According to an exemplary embodiment, stabilizers 17 can function as vertical and horizontal stabilizers, especially as shown in FIGS. 12 and 13. However, according to alternative embodiments, with a different orientation, or, for example, with three or another odd number of stabilizers 17, then each stabilizer can include functional aspects of both vertical and horizontal stabilization control surfaces. According to another exemplary embodiment, each stabilizer includes flight control surface 18 and according to a preferred embodiment, two of the four surfaces would include solar radiation panel 24, as shown in FIG. 12. As those of ordinary skill in the art can appreciate, however, other configurations are possible and can be considered within the scope of the several exemplary embodiments, including, for example, putting solar panels on more than two of the four panels.

As discussed above, tail boom 14 is connected to tail structure 16 via rotational pivot 20. According to an exemplary embodiment, rotation pivot 20 allows tail structure 16 to freely rotate via control of control system 22. Control of rotation of tail structure 16 can be accomplished by altering flight control surfaces 18, via control system 22, or by rotating tail structure 16 via a motor, for example. According to an exemplary embodiment, tail structure 16 and stabilizers 17a-d can be configured as two horizontal stabilizers 17c, d with elevation flight control surfaces (elevators) 18c, d, and two vertical stabilizers 17a, b with yaw flight control surfaces (rudders) 18a, b. However, as those of ordinary skill in the art can appreciate, as tail structure 16 rotates with respect to tail boom 14 (along with respect to the remaining portion(s) of MC UAV 2 and aircraft 100), each flight control surface 18 can operate in manner different than before rotation. Solar radiation panels 24, as shown in FIGS. 12 and 13, can be added to two of the surfaces of stabilizers 17, providing additional solar radiation energy collection surface area.

With the addition of solar radiation panels 24 to stabilizers 17a-b as shown in FIGS. 12 and 13 according to an exemplary embodiment, the orientation of tail structure 16 affects the collection and storage of electrical energy. Tail structure 16 can be rotated such that collection of solar radiation energy is substantially optimized.

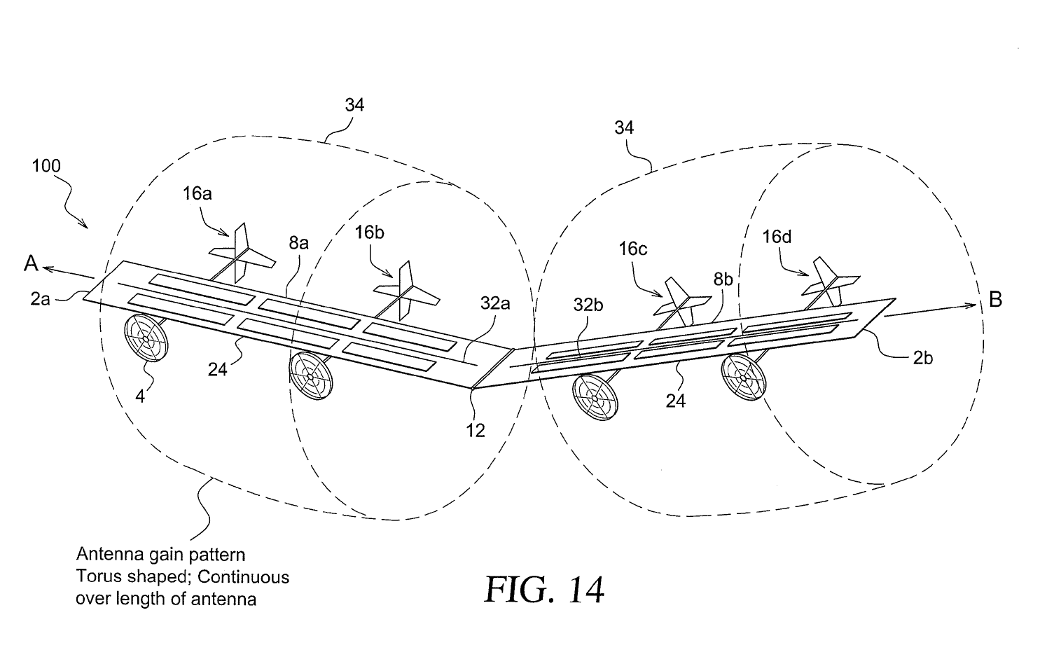

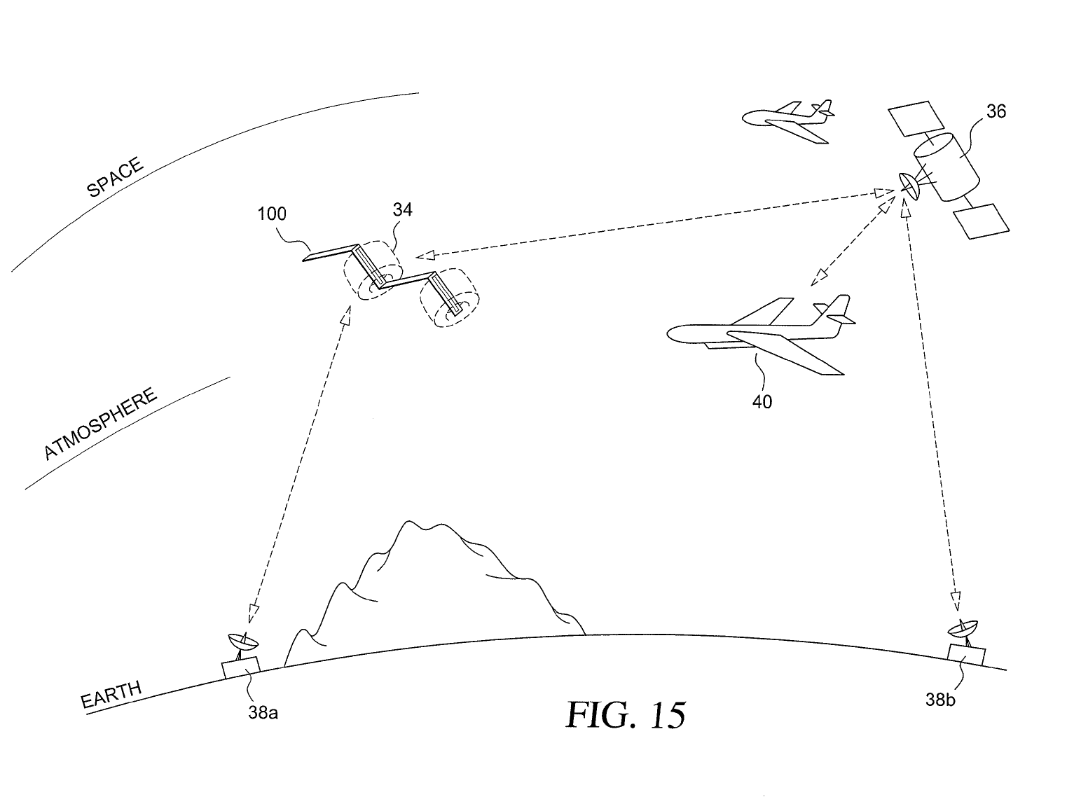

FIG. 14. illustrates a front perspective view of aircraft 100 implementing a non-planar adaptive wing structure and dipole antenna 32 embedded onto the wing structure according to an exemplary embodiment. FIG. 15 illustrates aircraft 100 as shown in FIG. 14 being used as a communication transceiver according to an exemplary embodiment. As discussed briefly above, aircraft 100 can be used to carry many different types of payloads. For example, aircraft 100 can carry radars, radios, infra-red detectors, and other types of devices. According to an exemplary embodiment another payload that can be carried by aircraft 100 is an antenna. According to a specific embodiment, the antenna can be a dipole antenna, and can be used to communicate with satellites, other aircraft, and ground and ship board transceivers.

As is well known to those of ordinary skill in the art of antennas, the radiation pattern of a dipole antenna is shaped as a torus, and is influenced by the frequency of the transmitting/receiving signal, length of the antenna, and other parameters. The center of the torus lies parallel to and along the dipole antenna element itself. Therefore, if dipole antenna 32 is placed on wing panel 8 on MC UAV 2 as shown in FIG. 14, then the gain pattern 34 of dipole antenna 32 faces perpendicular, in all directions, to each of dipole elements 32a, b. Therefore, MC UAV 2, and aircraft 100 can be used to great effect as a repeater between ground based transceivers located at ground stations 38a, b, and, for example, satellites 36 in space. Little or no transmission capability lies in the same direction that dipole elements 32a, b point, because of the lack of gain in those directions). Thus, there is little or no communication capability along the direction of arrows A and B in FIG. 14. Antenna gain pattern 34, as shown in FIG. 14, is shaped as a torus (which is generally donut shaped), as briefly discussed above. Therefore, it is substantially continuous along the length of each dipole element 32a, b. Antenna gain pattern 34 has been substantially simplified in FIG. 14 to illustrate the operation of dipole antenna 32a, b.

According to an exemplary embodiment, dipole antenna 32 can be a separate element in regard to wing panel 8. According to a preferred embodiment, dipole antenna 32 can be an integral component of wing panel 8 such as, for example, a wing spar the traverses substantially the entire length, or a portion thereof, of wing panel 8. In the latter, preferred embodiment, as long as the spar is suitably conductive, it can be used as a dipole antenna. A detailed description of the interconnection of dipole antenna 32, whether as a stand-alone or separate element, or an integral component of wing panel 8, to a transceiver (not shown) is, as those of ordinary skill in the art can appreciate, neither necessary for an understanding of the invention, nor within the scope of this discussion. Therefore, for the dual purposes of clarity and brevity, a detailed discussion of the interconnection of dipole antenna 32 to a transceiver and its operation for all of its various embodiments has been omitted.

Dipole antenna 32 on aircraft 100 can be used in many different scenarios. For example, a communications link can be created between ground-based personnel (e.g., police, border patrol, among others) and other related personnel at distant locations via a satellite or airborne communication link, as shown in FIG. 15. For example, if the ground based personnel represented by 38a are in an extremely mountainous terrain, satellite communication links can be extremely unreliable and/or non-existent. Using aircraft 100, with its extremely long loitering and high altitude operational capabilities provides an ideal communication transceiving function to allow the personnel on the ground to communicate to the outside world readily. Other examples include providing communications capabilities for remote villages so that distance based learning centers can be established. Depending on terrain and other factors, use of aircraft 100 with dipole antenna 32 can be most advantageous.

According to an exemplary embodiment, in operation, dipole antenna 32 needs to be properly aligned to satellite 36 (or another communication objective) in much the same that solar panels 8 need to be aligned with the sun. Of course, if air vehicle includes solar panels 8 and dipole antennas 32, there can be a conflict between maximizing antenna gain of dipole antenna 32 and maximizing solar energy collection (as those of ordinary skill in the art can appreciate, both solar panels and dipole antenna 32 are substantially similar in that both are antennas, and thus operate in accordance with well known electromagnetic principles). However, because of the unique nature of wing panels 8 and the special configuration of aircraft 100, much of the difficulty in cross alignment can be substantially minimized because of their ability to orient themselves at several different angle with respect to each other. That is, very often one or two wing panels can be oriented to the sun, to maximize solar radiation exposure, while two or more wing panels 8 can be oriented to maximize antenna gain in the direction of the airborne or space-based transceiver/communication-objective. Maximization, in this case, might mean less than optimal, but still better than a flat panel wing, for either solar exposure or dipole antenna 32 orientation.

The present invention has been described with reference to certain exemplary embodiments thereof. However, it will be readily apparent to those skilled in the art that it is possible to embody the invention in specific forms other than those of the exemplary embodiments described above. This may be done without departing from the spirit and scope of the invention. The exemplary embodiments are merely illustrative and should not be considered restrictive in any way. The scope of the invention is defined by the appended claims and their equivalents, rather than by the preceding description.

All United States patents and applications, foreign patents, and publications discussed above are hereby incorporated herein by reference in their entireties.

1. A method of operating an aircraft having a first wing panel, a second wing panel, and an aircraft electric motor, comprising the steps of:
rotating the first wing panel with respect to the second wing panel, wherein the first and second wing panels are rotational coupled;
collecting solar radiation energy by photovoltaic cells located on one or both of an upper surface and a lower surface of each of the first and second wing panels; and
energizing the aircraft electrical motor with the collected solar radiation energy.

2. The method according to claim 1, wherein the step of rotating the first wing panel comprises:
optimizing collection of solar radiation energy by the photovoltaic cells by rotating each of the first and second wing panels such that each is at an optimal angle with respect to the sun.

3. The method according to claim 1, further comprising:
rotating any number of wing panels, wherein each wing panel is rotationally coupled to at most two adjacent wing panels and at least one adjacent wing panel, such that each of the any number of wing panels can be rotated within a predetermined angular range with respect to each adjacent wing panel; and
optimizing collection of solar radiation energy by the photovoltaic cells on each wing panel by rotating each of the any number of wing panels such that each is at an optimal angle with respect to the sun.
